(19) United States
(12) Patent Application Publication
(10) Pub. No.: US 2012/0313552 A1
(43) Pub. Date: Dec. 13, 2012

(54) ORGANIC ELECTROLUMINESCENT DISPLAY DEVICE

(76) Inventors: Chia-Hsiung Chang, Tainan City (TW); Jyh-Yeuan Ma, Taoyuan County (TW)

(21) Appl. No.: 13/494,020

(22) Filed: Jun. 12, 2012

(30) Foreign Application Priority Data
Jun. 13, 2011 (TW) 100120542

(51) Int. Cl. H01J 5/16; H05B 33/12

(52) U.S. Cl. 315/312

(57) ABSTRACT

An organic electroluminescent display device includes a display array and a microlens array. The display array includes an organic light emitting surface, a plurality of pixel regions, and a plurality of spacing regions. Each of the spacing regions is disposed between two adjacent pixel regions. The microlens array is disposed on the organic light emitting surface and includes a plurality of first microlenses overlapping the spacing regions in a vertical projective direction. Each of the first microlenses includes a body part and a cambered part. Each of the first microlenses includes a first height and a diameter. The first height is larger than the diameter and smaller than twice the diameter.

### BACKGROUND OF THE INVENTION

1. Field of the Invention

The present invention relates to an organic electroluminescent display device, and more particularly, to an organic electroluminescent display device including a microlens array for enhancing the luminous efficacy and the display quality.

2. Description of the Prior Art

Because of certain advantages, such as being color filters free, self-lighting, backlight module free, and having low power consumption, the organic light emitting diode display device is regarded as a front runner to replace the conventional liquid crystal display device and become the mainstream display product of the next generation.

Generally, light generated by the organic light emitting diodes is not collimated light. For enhancing the luminous efficacy of the conventional organic light emitting diode display device, a microlens array is disposed entirely on the organic light emitting diode display device for guiding the large angled light, and the integrated display luminance is therefore enhanced.

Please refer to FIG. 1. FIG. 1 is a schematic diagram illustrating a conventional organic light emitting diode display device. As shown in FIG. 1, a conventional organic light emitting diode display device 60 includes a substrate 61, a lower electrode 62, a transparent electrode 63, a display light emitting layer 64, and a microlens array 65. The lower electrode 62 and the transparent electrode 63 are disposed on the substrate 61, and the display light emitting layer 64 is disposed between the lower electrode 62 and the transparent electrode 63. The microlens array 65 is disposed on the transparent electrode 63. In the conventional organic light emitting diode display device 60, the microlens array 65 is composed of a plurality of microlenses 65A, which are disposed entirely in the microlens array 65 and are disposed in close proximity to each other. Therefore, light L6 with a larger angle generated from the display light emitting layer 65 may be changed toward a direction which is closer to a viewing direction of a viewer, and the luminous efficacy of the conventional organic light emitting diode display device 60 may be enhanced. However, by using the entirely disposed microlenses 65A, light L5 with a smaller angle may not be guided to the viewer because a total reflection of the light L5 may be generated by the difference between the refraction index of the microlens 65A and the refraction index of the air, and the integrated luminous efficacy may be influenced. In addition, when two adjacent microlenses 65A respectively correspond to different sub-pixels with different colors, the light L6 with the larger angle may be guided by the microlens 65A and interferes with the adjacent sub-pixel. The display image may become blurred, and the display quality may be seriously affected.

### SUMMARY OF THE INVENTION

It is one of the objectives of the present invention to provide an organic electroluminescent display device. A microlens array is disposed on a light emitting surface of the organic electroluminescent display device. The size, the shape, and the allocation of each microlens are controlled for both enhancing the luminous efficacy and the display quality of the organic electroluminescent display device.

To achieve the purposes described above, a preferred embodiment of the present invention provides an organic electroluminescent display device. The organic electroluminescent display device includes a display array and a microlens array. The display array comprises a light emitting surface, a plurality of pixel regions, and a plurality of spacing regions. Each of the spacing regions is disposed between the two adjacent pixel regions. The microlens array is disposed on the light emitting surface of the display array. The microlens array includes a plurality of first microlenses overlapping the spacing regions in a vertical projective direction. Each of the first microlenses includes a body part and a cambered part, and the body part is disposed between the light emitting surface and the cambered part. Each of the first microlenses comprises a first height and a diameter. The first height is larger than the diameter and smaller than twice the diameter.

To achieve the purposes described above, another preferred embodiment of the present invention provides an organic electroluminescent display device. The organic electroluminescent display device includes a display array and a microlens array. The display array comprises a light emitting surface, a plurality of pixel regions, and a plurality of spacing regions. Each of the spacing regions is disposed between the two adjacent pixel regions. The microlens array is disposed on the light emitting surface of the display array and includes at least one stripe microlens overlapping the spacing region in a vertical projective direction. The stripe microlens comprises a first height and a diameter. The first height is larger than a width of the stripe microlens, and the first height of the stripe microlens is smaller than twice the width of the stripe microlens.

In the present invention, the microlens array is disposed on the light emitting surface of the organic electroluminescent display device. The relative dimension between the spacing regions, which are disposed between display pixels, and the microlenses, which are disposed over the spacing region, is controlled for improving the luminous efficacy and the display quality of the organic electroluminescent display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional organic light emitting diode display device.

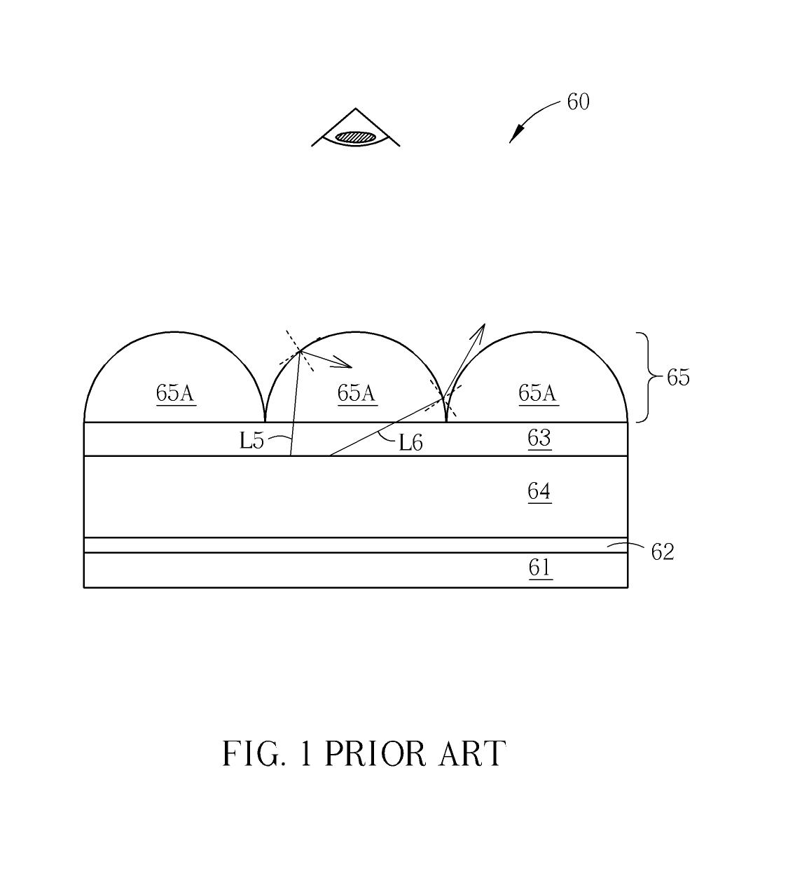

FIG. 2 is a schematic diagram illustrating a cross-sectional view of an organic electroluminescent display device according to a first preferred embodiment of the present invention.

FIG. 3 is a schematic diagram illustrating a top view of an organic electroluminescent display device according to a first preferred embodiment of the present invention.

FIG. 4 is a schematic diagram illustrating a display condition of an organic electroluminescent display device according to a first preferred embodiment of the present invention.

FIG. 5 is a schematic diagram illustrating a partially enlarged view of an organic electroluminescent display device according to a first preferred embodiment of the present invention.

FIG. 6 is a schematic diagram illustrating a partially enlarged view of an organic electroluminescent display device according to another preferred embodiment of the present invention.

FIG. 7 is a schematic diagram illustrating an organic electroluminescent display device according to a second preferred embodiment of the present invention.

FIG. 8 is a schematic diagram illustrating an organic electroluminescent display device according to a third preferred embodiment of the present invention.

FIG. 9 is a schematic diagram illustrating an organic electroluminescent display device according to a fourth preferred embodiment of the present invention.

### DETAILED DESCRIPTION

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” In addition, to simplify the descriptions and make it more convenient to compare between each embodiment, identical components are marked with the same reference numerals in each of the following embodiments. Additionally, the terms such as “first” and “second” in this context are only used to distinguish different components and do not constrain the order of generation.

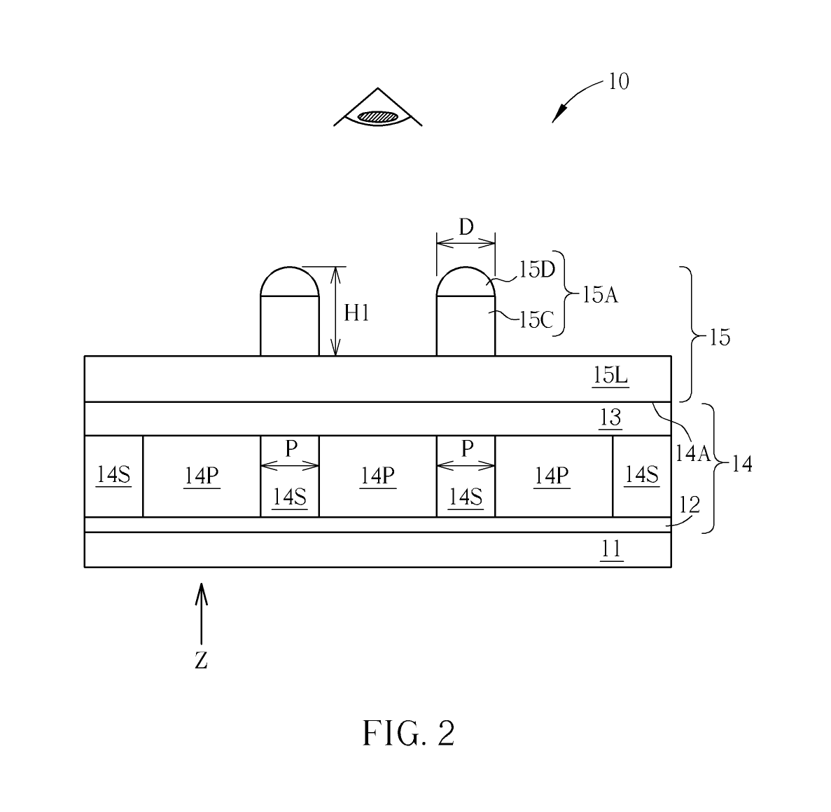

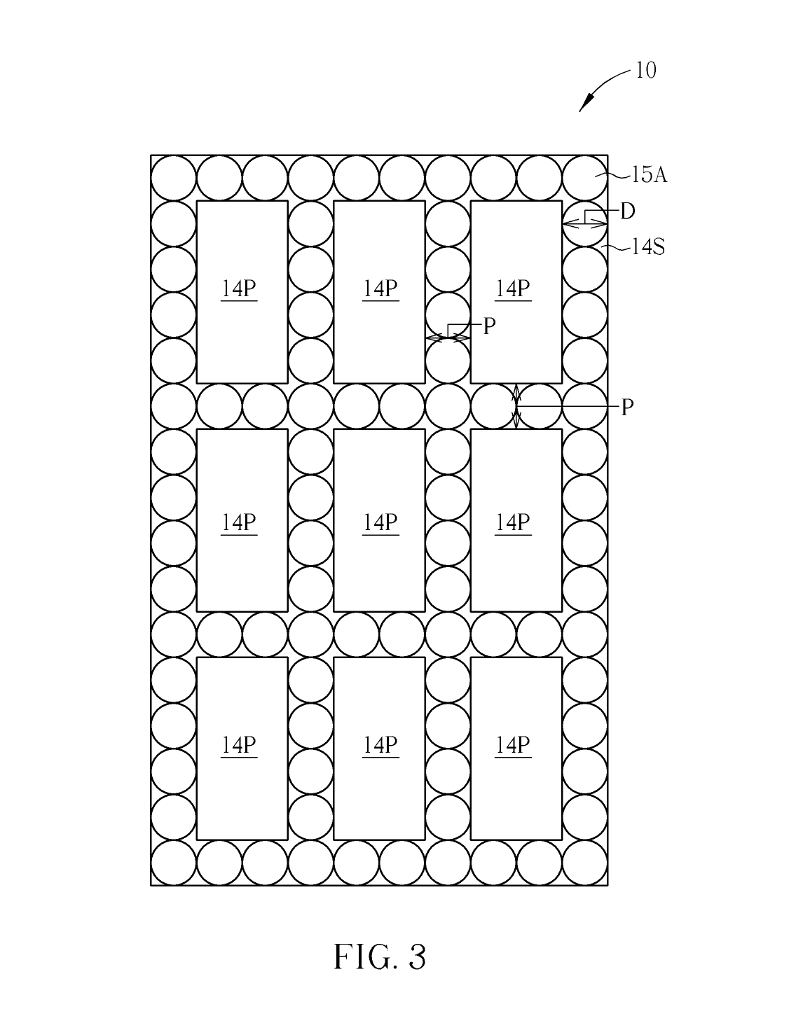

Please refer to FIG. 2 and FIG. 3. FIG. 2 is a schematic diagram illustrating a cross-sectional view of an organic electroluminescent display device according to a first embodiment of the present invention. FIG. 3 is a schematic diagram illustrating a top view of the organic electroluminescent display device according to the first embodiment of the present invention. Please note that the figures are only for illustration and the figures may not be to scale. The scale may be further modified according to different design considerations. As shown in FIG. 2 and FIG. 3, the organic electroluminescent display device 10 includes a substrate 11, a display array 14 and a microlens array 15. In this embodiment, the display array 14 includes an organic light emitting diode (OLED) display array, but not limited thereto. The display array 14 and the microlens array 15 are disposed on the substrate 11. The display array 14 has a light emitting surface 14A, and the display array 14 includes a plurality of pixel regions 14P and a plurality of spacing regions 14S. Each of the spacing regions 14S is disposed between the two adjacent pixel regions 14P. Each of the spacing regions has a spacing width P. The microlens array 15 is disposed on the light emitting surface 14A of the display array 14.

The microlens array 15 includes a plurality of first microlenses 15A. The first microlenses 15A overlap the spacing regions 14S in a vertical projective direction Z. In this embodiment, each of the first microlenses 15A includes a body part 15C and a cambered part 15D wherein the body part 15C is disposed between the light emitting surface 14A and the cambered part 15D. Each of the first microlenses 15A includes a first height H1 and a diameter D. The first height H1 of the first microlens 15A is larger than the diameter D of the first microlens 15A, and smaller than twice the diameter D of the first microlens 15A. The diameter D of the first microlens 15A is larger than half the spacing width P of the spacing region 14S, and smaller than or equal to the spacing width P of the spacing regions 14S. As shown in FIG. 2 and FIG. 3, the first microlenses 15A in this embodiment are disposed only on the spacing region 14S, but the present invention is not limited to this and the first microlens 15A may partially overlap the pixel region 14P in the vertical projective direction Z according to different design considerations.

Additionally, in this embodiment, a refraction index of the first microlens 15A may be between 1.3 and 2, but the present invention is not limited to this and other microlenses with other appropriate refraction indexes can also be employed in the present invention. The microlens array 15 in this embodiment may further include a transparent material layer 15L. The transparent material layer 15L may be disposed between the first microlens 15A and the light emitting surface 14A, and a refraction index of the transparent material layer 15L may be substantially smaller than or equal to the refractive of the first microlens 15A, but the present invention is not limited to this. According to different considerations, the first microlens 15A and the transparent material layer 15L may be made the same material or different materials for optimizing the performance.

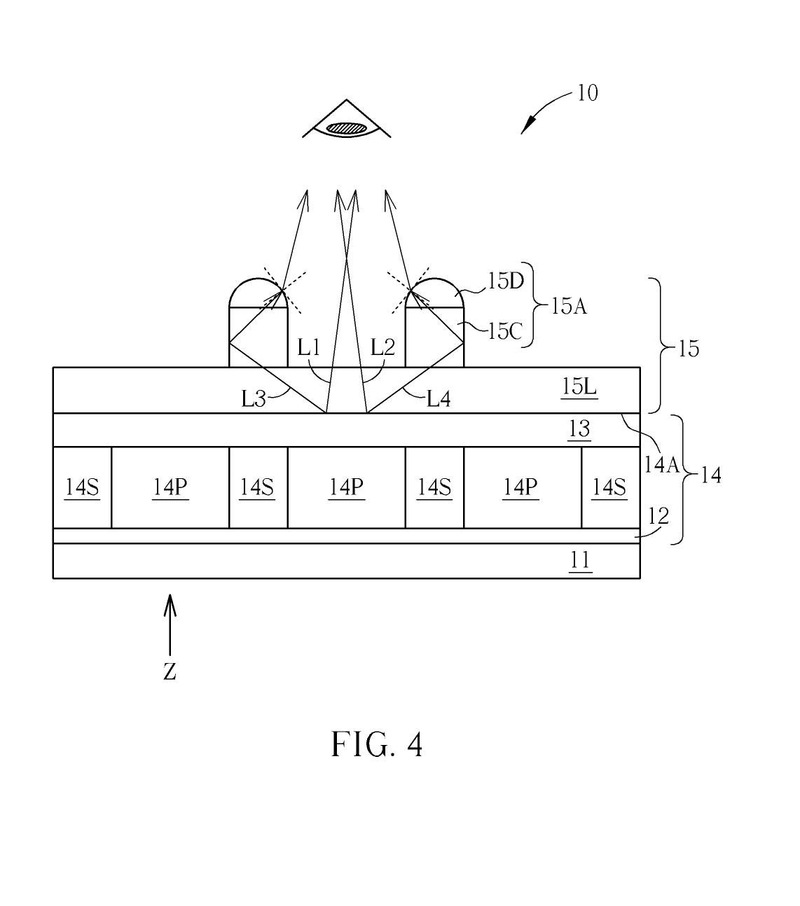

For detailing display approaches of the organic electroluminescent display device 10 in the first embodiment, please refer to FIG. 4. FIG. 4 is a schematic diagram illustrating a display condition of the organic electroluminescent display device according to the first embodiment of the present invention. As shown in FIG. 4, small angled light L1, small angled light L2, large angled light L3, and large angled light L4 are generated from the display array 14 of the organic electroluminescent display device 10. The small angled light L1/L2 and the large angled light L3/L4 are emitted from the light emitting surface 14A and then guided to the viewer via the microlens array 15. It is worth noticing that, in the present invention, the luminous efficacy may be enhanced because the small angled light L1/L2 may be emitted directly to the viewer without generating total reflection in the first microlens 15A. In addition, the large angled light L3/L4 may irradiate into the first microlens 15A, and the large angled light L3/L4 may be then guided toward a viewing direction of the viewer according to optical properties of the first microlens 15A. Therefore, the large angled light L3/L4 generated from each of the pixel regions 14P may not influence the adjacent pixel regions 14P, and the display quality of the organic electroluminescent display device 10 may then be enhanced.

More specifically, as shown in FIG. 4, after entering the body part 15C of the first microlens 15A, the large angled light L3/L4 may be guided toward the cambered part 15D of the first microlens 15A according to material properties or structures of the body part 15C. For instance, side walls of the body part 15C may be capable of reflecting light, but not limited thereto. The large angled light L3/L4 entering the cambered part 15D may then be guided toward the viewing direction of the viewer according to material properties and contour design of the cambered part 15D, and the large angled light L3/L4 may not influence other display light from other pixel regions 14P. Additionally, the microlens array 15 in this embodiment may further include the transparent material layer 15L disposed between the first microlens 15A and the light emitting surface 14A, and the large angled light L3/L4 may pass through the transparent material layer 15L before entering the first microlens 15A. An incidence angle and a light guiding condition of the large angled light L3/L4 in the first microlens 15A may be modified by tuning a thickness and a refraction index of the transparent material layer 15L.

Additionally, as shown in FIG. 2 and FIG. 4, the display array 14 in this embodiment may further include a lower electrode 12 and an upper electrode 13. The upper electrode 13 may be made of transparent conductive material such as indium tin oxide (ITO), and the lower electrode 12 may be made of transparent conductive material such as indium tin oxide, or a non-transparent conductive material such as metal, but not limited thereto. When the lower electrode 12 is made of a non-transparent conductive material which is capable of reflecting light, the organic electroluminescent display device 10 in this embodiment may be regarded as a top emission organic electroluminescent display device, but the present invention is not limited to this.

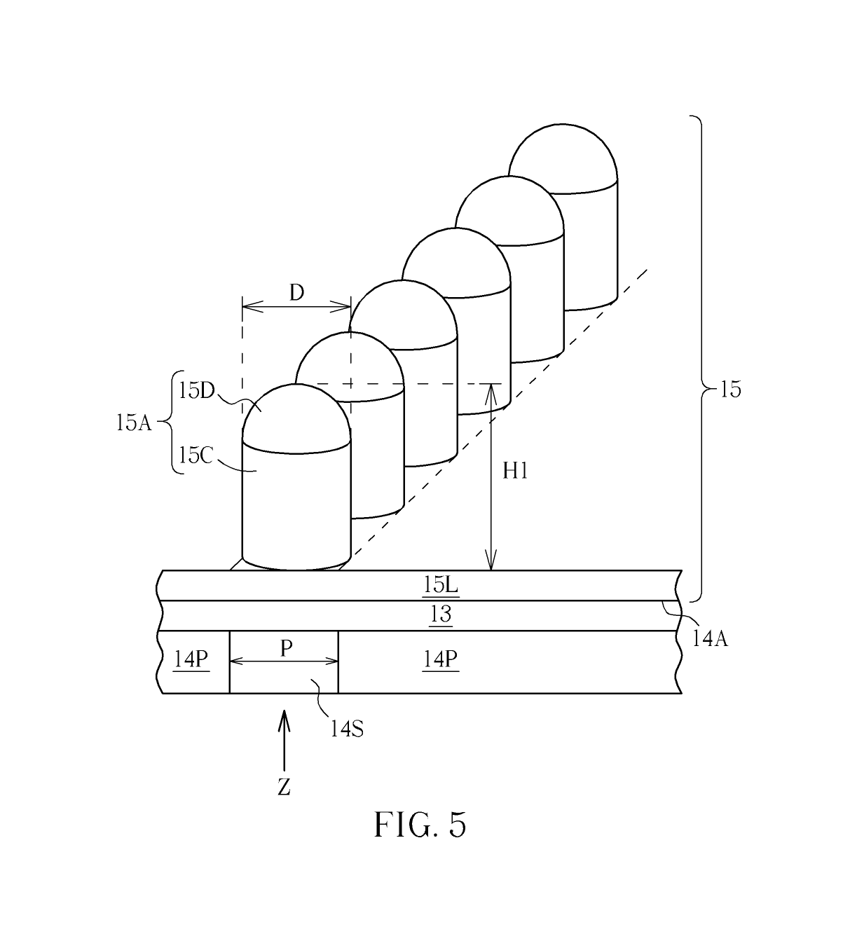

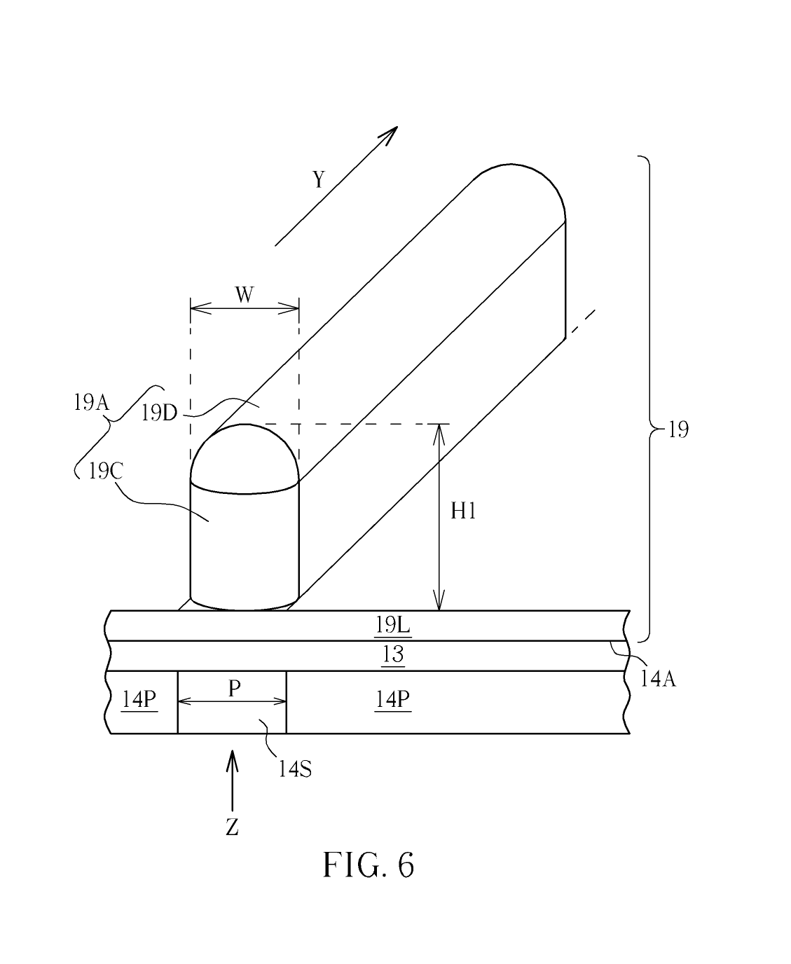

Please refer to FIG. 5, FIG. 6, and FIG. 2. FIG. 5 is a schematic diagram illustrating a partially enlarged view of the organic electroluminescent display device according to the first embodiment of the present invention. FIG. 6 is a schematic diagram illustrating a partially enlarged view of an organic electroluminescent display device according to another embodiment of the present invention. As shown in FIG. 5 and FIG. 2, in the first embodiment of the present invention, the microlens array 15 may include a plurality of first microlenses 15A overlapping the spacing region 14S in the vertical projective direction Z. Each of the first microlenses 15A includes a body part 15C and a cambered part 15D. In this embodiment, the cambered part 15D may include a hemispheroid, and the body part 15C may include a cylinder, but not limited thereto.

As shown in FIG. 6, in another embodiment of the present invention, a microlens array 19 may include at least a stripe microlens 19A overlapping the spacing region 14S in the vertical projective direction Z. The strip microlens 19A may include a cambered part 19D and a body part 19C. The microlens array 19 may include a transparent material layer 19L disposed between the strip microlens 19A and the light emitting surface 14A. A first height H1 of the stripe microlens 19A is substantially larger than a width W of the stripe microlens 19A, and smaller than twice the width W of the stripe microlens 19A. In addition, the width W of the stripe microlens 19A is substantially larger than half a spacing width P of the spacing region 14S, and smaller than or equal to the spacing width P of the spacing region 14S. It is worth noticing that the stripe microlens 19A in this embodiment may be disposed to stretch along a horizontal direction Y parallel to an edge of the spacing region 14S, the cambered part 19D may include a stripe curved surface body, and the body part 19C may include a pillar object stretching along the horizontal direction Y, but the present invention is not limited to this and the shape of the stripe microlens 19A may be further modified for optimizing the performance according to different design considerations. In addition, the other components and the material properties of this embodiment are similar to the first embodiment and will not be redundantly described.

The following description will detail the different embodiments of the organic electroluminescent display device in the present invention. To simplify the description, the identical components in each of the following embodiments are marked with identical symbols. For making it easier to compare the difference between the embodiments, the following description will detail the dissimilarities among different embodiments and the identical features will not be redundantly described.

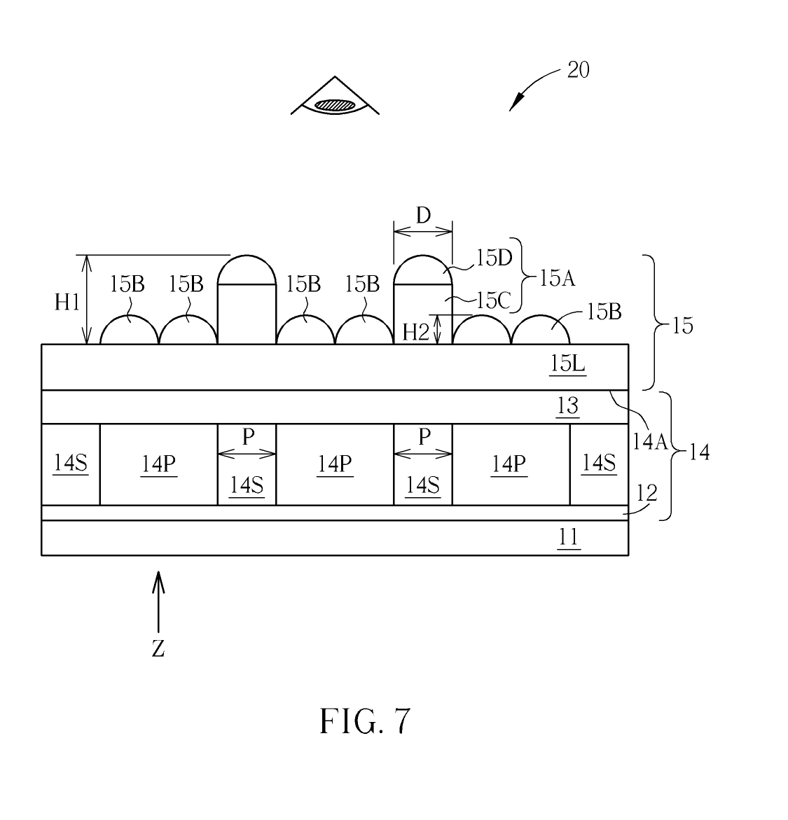

Please refer to FIG. 7. FIG. 7 is a schematic diagram illustrating an organic electroluminescent display device according to a second embodiment of the present invention. As shown in FIG. 7, the organic electroluminescent display device 20 includes a substrate 11, a display array 14, and a microlens array 15. The difference between this embodiment and the first embodiment is that the microlens array 15 of this embodiment further includes a plurality of second microlens 15B. Each of the second microlenses 15B overlaps the pixel region 14P in the vertical projective direction Z.

Additionally, a second height H2 of each of the second microlenses 15B is substantially smaller than or equal to half the first height H1 of the first microlens 15A, but the present invention is not limited to this and the relative size and the relative heights of the first microlens 15A and the second microlens 15B may be further modified according to different considerations. A refractive index of each of the second microlenses 15B is preferably between 1.3 and 2, but not limited thereto. The luminous efficacy of the organic electroluminescent display device may be further enhanced by disposing the second microlenses 15B in the microlens array 15 and optimizing the optical properties and the shape of the second microlens 15B. Except for the second microlenses 15B, the other components and the material properties of this embodiment are similar to the first embodiment detailed above and will not be redundantly described.

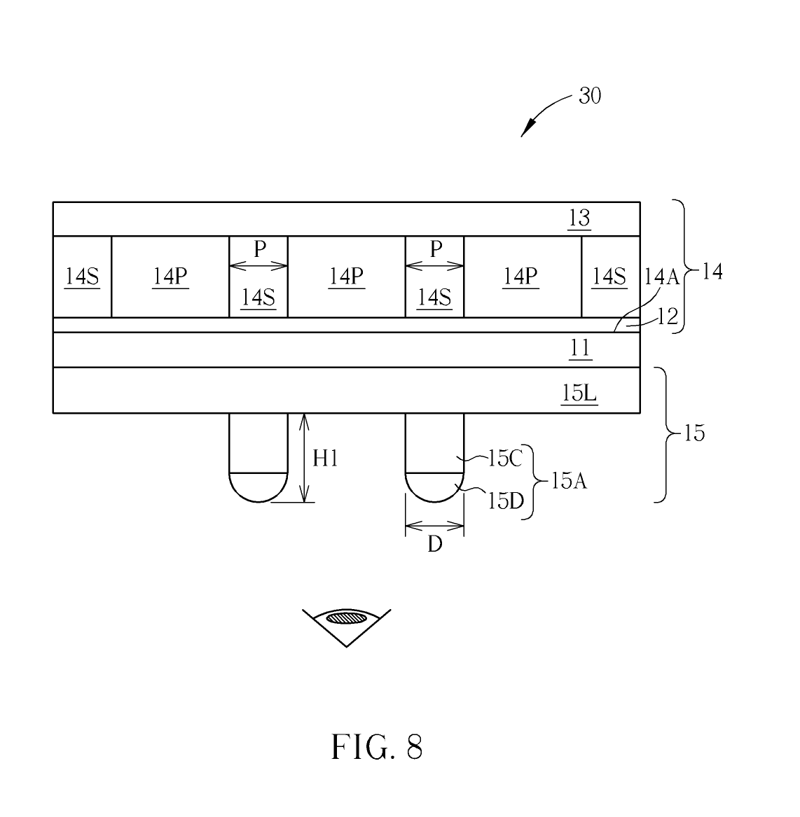

Please refer to FIG. 8, which is a schematic diagram illustrating an organic electroluminescent display device according to a third embodiment of the present invention. As shown in FIG. 8, the organic electroluminescent display device 30 includes a substrate 11, a display array 14, and a microlens array 15. The difference between this embodiment and the first embodiment is that the substrate 11 in this embodiment is disposed between the display array 14 and the microlens array 15. It is worth noticing that the display array 14 of this embodiment may include a lower electrode 12 and an upper electrode 13. The lower electrode 12 may be made of transparent conductive material such as indium tin oxide, and the upper electrode 13 may be made of transparent conductive material such as indium tin oxide, or a non-transparent conductive material such as metal, but not limited thereto. When the upper electrode 13 of the organic electroluminescent display device 30 is made of a non-transparent conductive material which is capable of reflecting light, the organic electroluminescent display device 30 in this embodiment may be regarded as a bottom emission organic electroluminescent display device, but the present invention is not limited to this. Except for the relative allocation between the substrate, the display array 14 and the microlens array 15, the components and the material properties of this embodiment are similar to the first embodiment detailed above and will not be redundantly described.

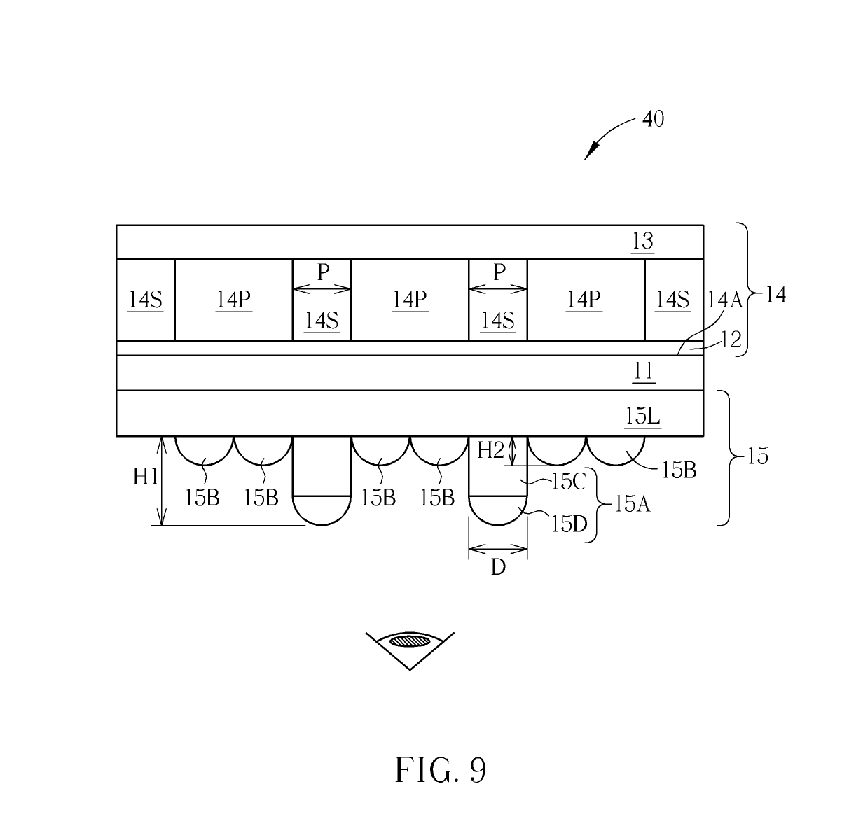

Please refer to FIG. 9 that is a schematic diagram illustrating an organic electroluminescent display device according to a fourth embodiment of the present invention. As shown in FIG. 9, the organic electroluminescent display device 40 includes a substrate 11, a display array 14, and a microlens array 15. The difference between this embodiment and the third embodiment described above is that the microlens array 15 of this embodiment further includes a plurality of second microlenses 15B overlapping the pixel region 14P in the vertical projective direction Z. The properties about the second microlens 15B are detailed in the second embodiment and will not be redundantly described. Similar to the third embodiment described above, when the upper electrode 13 of the organic electroluminescent display device 40 is made of a non-transparent conductive material which is capable of reflecting light, the organic electroluminescent display device 40 in this embodiment may be regarded as a bottom emission organic electroluminescent display device, but the present invention is not limited to this. It is worth noticing that, in each of the embodiments described above, different types of microlenses such as the cylinder microlenses or the stripe microlenses may be arranged in one microlens array for optimizing the performance according to different design considerations.

To summarize all the descriptions above, in the present invention, the microlens array is disposed on the light emitting surface of the organic electroluminescent display device. The luminous efficacy and the display quality of the organic electroluminescent display device may be enhanced by modifying the allocation of the microlenses in the microlens array and modifying the relative dimensions between the spacing regions, the pixel regions, and the microlenses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An organic electroluminescent display device, comprising:
a display array comprising a light emitting surface, a plurality of pixel regions and a plurality of spacing regions, wherein each of the spacing regions is disposed between the two adjacent pixel regions; and
a microlens array disposed on the light emitting surface of the display array, and comprising a plurality of first microlenses overlapping the spacing regions in a vertical projective direction, wherein each of the first microlenses comprises a body part and a cambered part, and the body part is disposed between the light emitting surface and the cambered part;
wherein each of the first microlenses comprises a first height and a diameter; the first height is larger than the diameter and smaller than twice the diameter.

2. The organic electroluminescent display device of claim 1, wherein the body part comprises a cylinder and the cambered part comprises a hemispheroid.

3. The organic electroluminescent display device of claim 1, wherein each of the spacing regions comprises a spacing width; the diameter is larger than half the spacing width, and smaller than or equal to the spacing width.

4. The organic electroluminescent display device of claim 1, wherein each of the first microlenses comprises a refractive index between 1.3 and 2.

5. The organic electroluminescent display device of claim 1, wherein the microlens array further comprises a plurality of second microlenses overlapping the pixel regions in the vertical projective direction.

6. The organic electroluminescent display device of claim 5, wherein each of the second microlenses comprises a refractive index between 1.3 and 2.

7. The organic electroluminescent display device of claim 5, wherein each of the second microlenses comprises a second height smaller than or equal to half the first height.

8. The organic electroluminescent display device of claim 1, wherein the microlens array further comprises a transparent material layer disposed between the first microlenses and the light emitting surface, and comprising a refractive index smaller than or equal to the refractive of the first microlenses.

9. An organic electroluminescent display device, comprising:
a display array comprising a light emitting surface, a plurality of pixel regions and a plurality of spacing regions, wherein each of the spacing regions is disposed between the two adjacent pixel regions; and
a microlens array disposed on the light emitting surface of the display array, and comprising at least one stripe microlens overlapping the spacing region in a vertical projective direction;
wherein the stripe microlens comprises a first height and a width; the first height is larger than the width and smaller than twice the width.

10. The organic electroluminescent display device of claim 9, wherein each of the spacing regions comprises a spacing width; the width is larger than half the spacing width, and smaller than or equal to the spacing width.
